(19) United States
(12) Patent Application Publication
(10) Pub. No.: US 2005/0015386 A1
(43) Pub. Date: Jan. 20, 2005

(54) Data management using dispersed and disparate databases

(76) Inventors: Justin Mortensen, Wichita, KS (US); James Pate, Derby, KS (US)

Correspondence Address: LSI LOGIC CORPORATION, 1621 BARBER LANE, MS: D-106, MILPITAS, CA, 95035, US

(21) Appl. No.: 10/621,085

(22) Filed: Jul. 15, 2003

(51) Int. Cl. G06F 7/00

(52) U.S. Cl. 707/100

(57) ABSTRACT

A clearinghouse maintains a database of metadata about CAD and other product related data across disparate and dispersed databases. The various databases may be located behind corporate firewalls. A CAD plug-in application or standalone application may communicate with the clearinghouse using an easily transportable protocol such as HTTP and XML protocols to sort, browse, and request data from the disparate and dispersed databases. The clearinghouse may retrieve the requested data, translate the data if necessary, and send the requested data to the user. The user may also publish or otherwise notify the clearinghouse of data that is able to be shared.

### BACKGROUND OF THE INVENTION

a. Field of the Invention

The present invention pertains to computer aided design data management systems and specifically to the management of dispersed data that have differing file types.

b. Description of the Background

Computer aided design (“CAD”) projects often requires multiple users to work together to complete a design. In many cases, two or more groups of CAD designers from different locations may work on a single design. Sharing CAD data between different users and especially between users in different locations is complicated by the fact that the various users may not all be operating the same CAD system.

Product Data Management (“PDM”) systems are specialized database management systems that are tailored to manage CAD and other data that is associated with a manufactured product. PDM systems that handle CAD data typically have various mechanisms to manage revision control of parts, effectivity dates, and the like, as well as allowing users to check in and out files for modification.

Typically, a company or, in some large corporations, each division of a corporation, may have its own PDM systems and procedures. These PDM systems and procedures may work well on their own, but may cause problems when collaborative work is attempted between companies because the PDM systems and procedures of one company or division may be different and in some ways incompatible with those of another company or division.

One typical problem is compatibility of data formats. The data structures used by one CAD tool may be fundamentally different from that of another CAD tool. A collaborative project between two groups of designers that use different CAD tools may cause a significant amount of problems in the translation and management of data.

Another problem of collaboration between two or more different companies is the prevalence of firewalls and other restrictions in free data communication. In order to pass through a firewall, data must be formatted in specific protocols. Such protocols are typically not used for CAD or PDM data.

With today's systems, there is no mechanism to readily share data between companies. In a typical transaction, a first designer at a first company would call a second designer at a second company. The second designer would retrieve CAD data from the second company database and email or otherwise send the requested data to the first designer. Either the first or second designer may translate the CAD data if different CAD tools were being used by the designers.

It would therefore be advantageous to provide a CAD data management system that is compatible with and facilitates the use of many different CAD design tools. It would be further advantageous if such a system were adapted to operate across disparate databases that may be located in dispersed locations and behind different firewalls. Additionally, it would be advantageous if such a system were capable of handling files or data of any sort.

### SUMMARY OF THE INVENTION

The present invention overcomes the disadvantages and limitations of the prior art by providing a system and method for managing CAD data across disparate and dispersed databases, the system being composed of a web services clearinghouse that maintains a database of registered CAD data. The registered CAD data may be located in different databases in different locations. A plug-in program is provided for various CAD systems that allow HTTP and XML messages to be sent directly to the web services clearinghouse to request and receive data, including CAD data in whatever format is necessary.

A plug-in program may allow a user to browse the available files registered in the web services clearinghouse and request a file or set of files. Those files may be located on a database in a remote location behind at least one firewall. The web services clearinghouse may then retrieve the requested data from the remote database, translate the data as necessary, and transfer the requested data to the plug-in. The plug-in may then convert the data as necessary into the format requested.

The clearinghouse may maintain a database of the metadata of various files and data located in the disparate and dispersed databases, but in general the clearinghouse may not maintain the actual data. The clearinghouse may perform authentication, authorization, and accounting services in addition to security and various levels of controlled access to the data.

The various databases that are accessed by the clearinghouse may or may not have a plug-in or other specialized communications program that enables communication between the database and the clearinghouse. In some embodiments, a local PDM system may have a plug-in that enables communication to the clearinghouse while in other embodiments, the CAD tool plug-in may incorporate such functions.

The present invention may therefore comprise a method of managing CAD data in a plurality of disparate and diverse databases comprising: providing a first database located in a first location and further being located behind a first firewall; providing a second database located in a second location and further being located behind a second firewall; providing a clearinghouse server located outside of the first firewall and the second firewall, the clearinghouse server having a clearinghouse database comprising an index to at least a portion of the CAD data in the first database and at least a portion of the CAD data in the second database; providing a workstation located behind the first firewall, the workstation having a clearinghouse interface program; establishing communications between the clearinghouse interface program with the clearinghouse server; transmitting a request for a requested file from the clearinghouse interface program to the clearinghouse server; determining that the requested file is located in the second database by using the clearinghouse database; sending a request from the clearinghouse server to the second database for the requested file; converting the requested file to a first transmittable format; and transmitting the requested file from the second database in the first transmittable format.

The present invention may further comprise a system for sharing files across disparate databases comprising: a first server located behind a first firewall and connected to a first database that contains a first set of files; a second server located behind a second firewall and connected to a second database that contains a second set of files; a clearinghouse server located outside of the first firewall and the second firewall; a clearinghouse database located on the clearinghouse server and having an index to at least a portion of the first set of files in the first database and at least a portion of the second set of files in the second database; a workstation located behind the first firewall and having a clearinghouse interface program capable of interfacing with the clearinghouse database on the clearinghouse server, the clearinghouse interface program further capable of sending a request for a specific file indexed in the clearinghouse database; the clearinghouse server further receives the request for the specific file from the workstation, determines that the specific file is located on the second database, and sends the request for the specific file to the second server; and the second server further receives the request for the specific file, locates the specific file in the second database, converts the specific file into a first transmittable format, and sends the specific file.

The advantages of the present invention are that collaborative parallel design functions may be greatly enhanced by managing CAD data through a web services clearinghouse. Those users with the appropriate permission may request CAD data through company firewalls, have that data retrieved, translated if necessary, and delivered simply and effectively in a process that was heretofore cumbersome and typically involved two people at each end of the transaction. Data security is maintained throughout the transaction.

### BRIEF DESCRIPTION OF THE DRAWINGS

In the drawings,

FIG. 1 is an illustration of an embodiment of the present invention showing a system for sharing files.

FIG. 2 is an illustration of an embodiment of the present invention showing the interactions of various components of a system for sharing files.

### DETAILED DESCRIPTION

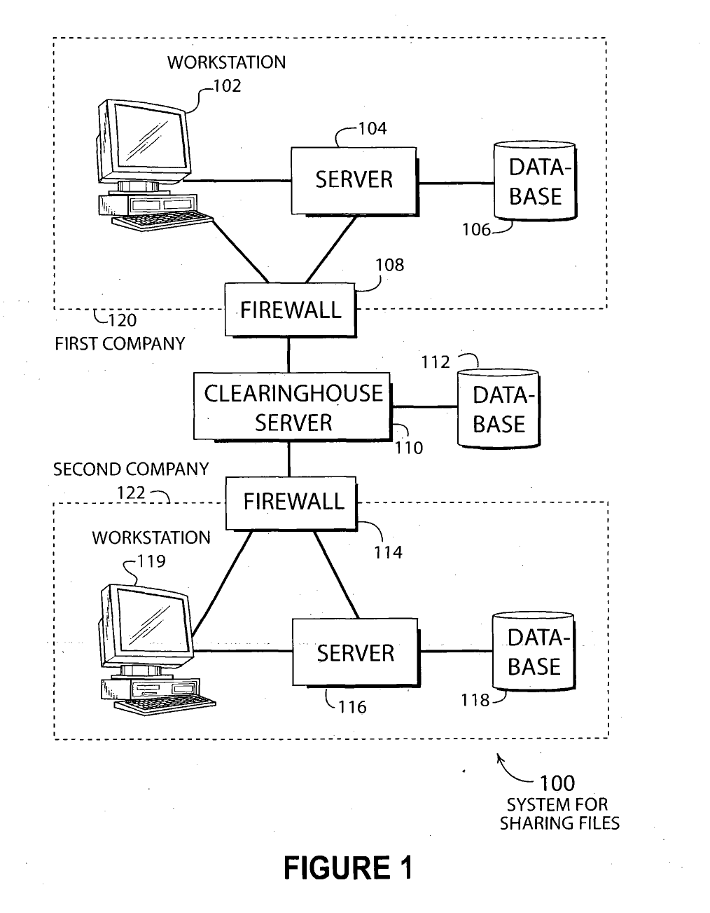

FIG. 1 illustrates an embodiment 100 of the present invention showing a system for sharing files. A workstation 102 is connected to a first server 104 and a first database 106. The workstation 102, the server 104, and the database 106 all reside behind a firewall 108. The firewall 108 allows communication to a clearinghouse server 110 that is connected to a clearinghouse database 112. The clearinghouse server 110 may communicate with a second firewall 114 that protects workstation 119, server 116, and database 118. The first firewall 108, workstation 102, server 104, and database 106 may reside in first company 120 while the second server 116 and database 118 may reside in second company 122.

The system of embodiment 100 may allow users from different companies to share files and information in a simple and easy manner. Each company may have its own database that is protected by a firewall. A clearinghouse server 110 may provide an index to each of the various databases and facilitate communication between the companies while allowing each company its freedom to operate independently.

For example, if first company 120 and second company 122 are going to perform a collaborative effort, such as designing various components or subsystems of a large project such as a car, there is likely to be a need for each company to share a portion of their databases with each other. In the example, if first company 120 is assigned the project of designing the brake system while second company 122 is designing the suspension, the designers of first company 120 may need the CAD model of the suspension to layout the routing of the brake lines. Conversely, second company 122 may need the caliper design from first company 120 in order to ensure that the calipers do no interfere with other portions of the suspension. The example is further complicated if the two companies are using different CAD systems.

In the example, each company typically has a firewall that prevents unauthorized access to a company's computer systems. The firewalls are typically configured so that HTTP and related protocols such as XML will pass through the firewall. However, direct access and transfer of any file type through the firewall is typically prohibited.

The clearinghouse server 110 may be configured with specific business logic to allow appropriate and necessary communications to occur between the companies. For example, only some files, such as a specific subset of the CAD data, may be allowed to be shared. Other files may be prohibited from being shared, as they may contain company sensitive information. Further, the clearinghouse server 110 may convert, translate, filter, or otherwise modify files or information that is sent from one company to another.

The clearinghouse server 110 allows each company to maintain their own separate databases without unnecessary duplication of data in two or more locations. In this manner, the clearinghouse server 110 may be used on a project by project basis. In other embodiments, the clearinghouse server 110 may be used by a company of multiple divisions in remote locations to manage the information transfer between divisions.

The clearinghouse server 110 may perform product data management (“PDM”) functions such as checking in and out of files that are being modified, assembling bills of materials, project timeline tracking, and other functions as may be defined by the business logic.

The clearinghouse database 112 may contain indexes of the various shared files or information contained in first company's database 106 and second company's database 118. As a file or other forms of information are ready to be shared in first company 120, the file or information may be published or released to the clearinghouse database 112. This process may involve identifying the file and providing searchable information concerning the file to the clearinghouse server 110. The clearinghouse server 110 may add this information to the database 1112. The business rules within the clearinghouse server 110 may define which users within first company 120 and second company 122 have the proper permissions and types of access to the file or information.

One set of business rules may define the overall interactions between the companies. For example, if the two companies are each using a different CAD system, one overall business rule may define the type of translation that may be applied to CAD files that are transferred. In another example, the overall business rules may define the specific protocol that may be used to communicate between each company.

Each file or piece of information may have business rules that are specifically applied to that file or piece of information. For example, a certain file may have the attributes of a draft version. Draft versions of files may be specially marked or annotated so that they are not relied upon for work that is done by others. Such markings or annotations may be applied by the clearinghouse server 110 when that file is transferred from one company to another.

The communication between the various servers generally occur through the firewalls. Thus, the communications may be performed using HTTP, XML, or other standard protocol that does not require special configuration of a firewall. For example, requests for a file or information may be sent using HTTP from a requesting user 102 to the clearinghouse server 110. The clearinghouse server 110 may send an HTTP request to the server 116. The server 116 may retrieve the requested file from the database 118 and then convert the file into XML or other transmittable format. The converted file may then be sent to the user's computer 102 which will convert the file back to the native format.

In some embodiments, the converted file may be transferred to the clearinghouse server 110 to be converted, merged, translated, manipulated, checked, verified, evaluated, encrypted, or otherwise analyzed and/or changed according to the business rules applicable. The clearinghouse server 110 may have various translators, analysis programs, or other functions as may be needed by the business rules. For example, the clearinghouse server 110 may have a multitude of CAD translators for converting various CAD formats. In some circumstances, it may be preferable to have a centralized translation function so that the various translators need not be resident in each server or user that sends or receives files.

In other embodiments, some conversion, analysis, encryption, or other changes to the requested file may be performed by the server that is preparing to send the file. For example, a requested file may have a date stamp, proprietary notation, or other addition made to the file by the server that is preparing to send the file. Such a modified file may be sent directly to the recipient or may be sent to the clearinghouse server 110 for additional modifications or for forwarding.

The embodiment 100 may be used for sharing and transferring any type of file or information. Within this specification, the term file shall include any piece of computer readable data in any form that may be shared between users. A ‘file’ may be a discrete file as it is saved by an operating system, or the ‘file’ may be a record in a database, an image or portion of an image, a block or portion of a database, or any other computer readable data that could be shared between users.

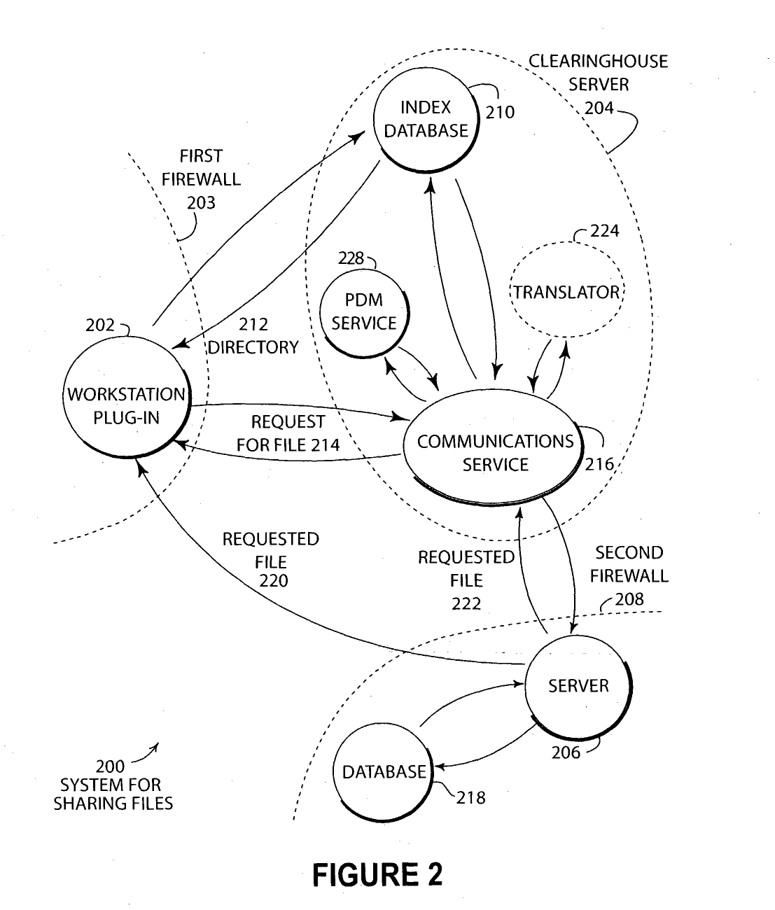

FIG. 2 illustrates an embodiment 200 of the present invention showing the interactions of various components of a system for sharing files. A workstation plug-in program 202 is in communication with a clearinghouse server 204 and a second server 206. The workstation 202 is behind a first firewall 203 while the server 206 is behind a second firewall 208. The workstation plug-in 202 may communicate with the index database 210 of the clearinghouse server 204 to retrieve a directory 212. Based on the directory listing 212, the workstation plug-in 202 may send a request a file 214 to the communications service 216 of the clearinghouse server 204. The communications service 216 may send a message to the second server 206 requesting the file, whereupon the second server 206 may retrieve the file from the database 218 and either transmit the requested file 220 directly to the workstation plug-in 202 or send the requested file 222 to the communications service 216. The communications service 216 may perform a translation on the file using a translator 224 and/or may perform some product data management functions using the PDM service 228 prior to sending the file 226 to the workstation plug-in 202.

The workstation plug-in 202 may be a plug-in application that operates in conjunction with another piece of software. In some embodiments, the workstation plug-in may be a standalone piece of software that is not used directly with another piece of software. One function of the workstation plug-in 202 is to provide a user with a directory of files or information that has been made available for sharing through the clearinghouse server 204. The index database 210 may have a listing of the various files or data that have been published to the clearinghouse server 204. The workstation plug-in 202 may display the directory 212 such that the user may select the file of their choosing.

The directory 212 that is made available to the workstation plug-in 202 may be a subset of the entire list of shared files. A filter may be applied to the directory 212 based on the business rules that are in place for that particular user. The business rules may, for example, limit the directory 212 to only those files that are available to that particular user for download. In another example, the user may be able to view the titles and status of a superset of files, but be restricted to being able to download a subset of files. In some cases, the business rules may restrict the user from one particular company from viewing certain files from a different company.

The workstation plug-in 202 may have a graphical interface for viewing and selecting files or data to request. In some embodiments, the workstation plug-in may allow for certain features or functions to be applied to the files or data when they are shared. For example, the workstation plug-in 202 may allow the user to check a box or otherwise indicate a certain translation to be performed on the file or for certain PDM functions to be applied, such as checking out the file for modification. These selections may cause the clearinghouse server 204 to perform ancillary or secondary processing of the file or adjust the file's parameters prior to sending the file to the workstation plug-in 202.

The workstation plug-in 202 may have the capability not shown for a user to publish files or data to the clearinghouse server 204 for sharing to other users. In some embodiments, a separate application may be used to publish such information. The act of publishing the information may involve identifying the data or file, selecting various parameters as may be necessary to indicate the type of sharing, authorization requirements, or other variables, and transmitting the information to the clearinghouse server 204.

The communications between the workstation plug-in 202, the clearinghouse server 204, and the server 206 may be handled using HTTP, XML, or other protocols that are transparent to the firewalls 203 and 208. For the transfer of files of other file types, the communication protocol may involve converting the file type into XML or other transportable protocol, transferring the file to the destination, and converting the file type from XML to the native file format. The workstation plug-in 202 may be capable of receiving XML or other transportable file types and converting those file types back into the native format. Additionally, encryption may be applied to the files or communications at their point of origin and may be decrypted at the point of reception. Such encryption/decryption may be applied to some or all of the transactions between the various computer systems. When HTTP protocol is used, some functions of the clearinghouse server 204 and the second server may be provided by web services technology.

The server 206 may have a standalone application or service that receives and processes requests for files. In some embodiments, such a service may be a plug-in or portion of a local PDM or file management system. For example, a company located behind the firewall 208 may have an internal PDM system that is used for checking in and out files to be modified and for managing the status of the files. The PDM system may take care of archiving, backing up the files, and other administrative tasks. The PDM system may be adapted to allow the users to set the status of certain files to allow those files to be shared using the clearinghouse server 204 and may additionally allow the users to select certain permissions or status items that may be used by the clearinghouse server 204 in performing its functions. In such an embodiment, the local PDM system may periodically send updates to the clearinghouse server 204 when files are marked for sharing using the clearinghouse server 204. Such an embodiment may have the advantage that the local users may use a tool with which they are familiar.

The server 206 may be capable of sending the requested file 220 directly to the workstation plug-in 202. In some embodiments, the clearinghouse server 204 may send the request for a file with address information for the workstation plug-in 202 such that the file transfer may occur without involving the clearinghouse server 204. In some cases, the server 206 and/or the workstation plug-in 202 may send a confirmation message to the clearinghouse server 204 to verify that the transaction has successfully taken place. In some embodiments, the individual transactions may be logged and recorded whereas in other embodiments, such logging may not be necessary.

The clearinghouse server 204 may have specific authentication, authorization, and accounting functions that are used with each user. The user of the workstation plug-in 202 may be authenticated when communication with the clearinghouse server 204 is initiated. For example, a password or key may be verified. The clearinghouse server 204 may authorize the user to a selected set of abilities or permissions appropriate to that user. Further, the clearinghouse server 204 may monitor the usage of the user and provide billing or other accounting functions based on various parameters, such as login time, amount of data requested, specific functions performed, etc. Those skilled in the arts may provide many different functions for the clearinghouse server 204 while maintaining within the spirit and intent of the present invention.

The communication server 204 may provide a common communication path between various companies or groups that are remotely located or have specific business needs that require control over or assistance for sharing computerized information. The communications server 204 may have certain business rules that define the appropriate interaction between companies. These business rules may involve permissions, access restrictions, filtering and translation of data passed between companies, and other rules as may be developed by those skilled in the arts. The functionality of the clearinghouse server 204 assists users in the sharing of information by providing a directory of selectable information and performing all ancillary and secondary processing of the requested information.

The clearinghouse server 204 may not necessarily have any company sensitive files or data stored at the clearinghouse server 204. Each company may therefore protect their own proprietary or sensitive information behind their own firewall and use their own archiving and backup processes. The security of maintaining their own archiving and backup processes would allow one company with very stringent processes to interact through the clearinghouse server 204 with another company that may have different processes without compromising either company's security processes.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method of managing CAD data in a plurality of disparate and diverse databases comprising:
providing a first database located in a first location and further being located behind a first firewall;
providing a second database located in a second location and further being located behind a second firewall;
providing a clearinghouse server located outside of said first firewall and said second firewall, said clearinghouse server having a clearinghouse database comprising an index to at least a portion of said CAD data in said first database and at least a portion of said CAD data in said second database;
providing a workstation located behind said first firewall, said workstation having a clearinghouse interface program;
establishing communications between said clearinghouse interface program with said clearinghouse server;
transmitting a request for a requested file from said clearinghouse interface program to said clearinghouse server;
determining that said requested file is located in said second database by using said clearinghouse database;
sending a request from said clearinghouse server to said second database for said requested file;
converting said requested file to a first transmittable format; and
transmitting said requested file from said second database in said first transmittable format.

2. The method of claim 1 wherein said workstation is a CAD workstation and said clearinghouse interface program is a plug-in application.

3. The method of claim 1 wherein said establishing communications between said clearinghouse interface program and said clearinghouse server comprises authenticating and authorizing said clearinghouse interface program.

4. The method of claim 1 further comprising:
converting said requested file from said first transmittable format to a first CAD format;
translating said requested file from said first CAD format to a second CAD format;
converting said requested file from said first CAD format to said second transmittable format;
transmitting said requested file to said first CAD station using said second transmittable format; and
converting said requested file from said second transmittable format to said second CAD format.

5. The method of claim 4 wherein said step of translating said requested file from said first CAD format to said second CAD format is performed by said clearinghouse server.

6. The method of claim 1 wherein said first transmittable format comprises XML.

7. A system for sharing files across disparate databases comprising:
a first server located behind a first firewall and connected to a first database that contains a first set of files;
a second server located behind a second firewall and connected to a second database that contains a second set of files;
a clearinghouse server located outside of said first firewall and said second firewall;
a clearinghouse database located on said clearinghouse server and having an index to at least a portion of said first set of files in said first database and at least a portion of said second set of files in said second database;
a workstation located behind said first firewall and having a clearinghouse interface program capable of interfacing with said clearinghouse database on said clearinghouse server, said clearinghouse interface program further capable of sending a request for a specific file indexed in said clearinghouse database;
said clearinghouse server further receives said request for said specific file from said workstation, determines that said specific file is located on said second database, and sends said request for said specific file to said second server; and
said second server further receives said request for said specific file, locates said specific file in said second database, converts said specific file into a first transmittable format, and sends said specific file.

8. The system of claim 7 wherein said first database contains files in a first CAD format and said second database contains files in a second CAD format.

9. The system of claim 8 wherein said clearinghouse server is further adapted to:
receive said specific file;
convert said specific file from said first transmittable format to said second CAD format;
translate said specific file from said second CAD format to said first CAD format;
convert said specific file from said first CAD format into a second transmittable format; and
transmit said specific file to said workstation.

10. The system of claim 7 wherein said clearinghouse interface program comprises a plug-in application.

11. The system of claim 7 wherein said transmittable format comprises XML.
